(19) United States
(12) Patent Application Publication
(10) Pub. No.: US 2026/0089543 A1
(43) Pub. Date: Mar. 26, 2026

(54) INFORMATION PROCESSING APPARATUS, COMMUNICATION SYSTEM, COMMUNICATION METHOD, AND PROGRAM

(71) Applicant: CASIO COMPUTER CO., LTD., Tokyo (JP)

(72) Inventors: Hiroaki OTSUBO, Tokyo (JP); Shuhei UCHIDA, Tokyo (JP); Takashi ITO, Tokyo (JP); Takeshi MATSUE, Tokyo (JP); Munetaka SEO, Tokyo (JP)

(21) Appl. No.: 19/336,847

(22) Filed: Sep. 23, 2025

(30) Foreign Application Priority Data
Sep. 24, 2024 (JP) 2024-165635

(51) Int. Cl. H04W 28/02; H04W 76/14

(52) U.S. Cl. CPC H04W 28/0215; H04W 76/14

(57) ABSTRACT

An information processing apparatus includes a processor that: sets a transmission priority of each of a first electronic apparatus capable of establishing a connection for communication with a terminal apparatus, and a second electronic apparatus capable of establishing a connection for communication with the terminal apparatus; in a case of acquiring information indicating that the terminal apparatus has established connections for communication with the first electronic apparatus and the second electronic apparatus and receiving first information received by the first electronic apparatus and second information received by the second electronic apparatus, determines whether the first information and the second information are of an identical type or not; and in a case of determining that the first information and the second information are of the identical type, decides which of the first information and the second information is to be transmitted to the terminal apparatus, based on the transmission priority having been set.

### CROSS-REFERENCE TO RELATED APPLICATIONS

This application is based on and claims the benefit of priority from Japanese Patent Application No. 2024-165635, filed on Sep. 24, 2024, the content of which is incorporated herein by reference.

### BACKGROUND OF THE INVENTION

### Field of the Invention

The present invention relates to an information processing apparatus, a communication system, a communication method, and a program.

### Related Art

Japanese Unexamined Patent Application, Publication No. 2021-136457 discloses a technology of connecting a plurality of mobile terminals to a vehicle-mounted device, by preferentially connecting a mobile terminal having a high priority when the number of mobile terminals simultaneously connectable to the vehicle-mounted device is smaller than the number of mobile terminals registered as communication connection targets.

### SUMMARY OF THE INVENTION

An information processing apparatus according to the present invention includes a processor that: sets a transmission priority of each of a first electronic apparatus capable of establishing a connection for communication with a terminal apparatus, and a second electronic apparatus capable of establishing a connection for communication with the terminal apparatus;

in a case of acquiring information indicating that the terminal apparatus has established connections for communication with the first electronic apparatus and the second electronic apparatus and receiving first information received by the first electronic apparatus and second information received by the second electronic apparatus, determines whether the first information and the second information are of an identical type or not; and in a case of determining that the first information and the second information are of the identical type, decides which of the first information and the second information is to be transmitted to the terminal apparatus, based on the transmission priority having been set.

### BRIEF DESCRIPTION OF THE DRAWINGS

FIG. 1 shows an overview of a communication system in an embodiment of the present invention;

FIG. 2 shows an example of notifications in the communication system in the embodiment of the present invention;

FIG. 3 shows a functional configuration of a first electronic apparatus in the embodiment of the present invention;

FIG. 4 shows a functional configuration of a second electronic apparatus in the embodiment of the present invention;

FIG. 5 shows a functional configuration of a terminal apparatus in the embodiment of the present invention;

FIG. 6 shows a functional configuration of a server in the embodiment of the present invention;

FIG. 7 shows a display example of a terminal apparatus;

FIG. 8 shows an example of setting a notification priority in the communication system in the embodiment of the present invention;

FIG. 9 shows another example of the communication system in the embodiment of the present invention;

FIG. 10 is a flowchart showing processing procedures of a communication method according to the embodiment of the present invention;

FIG. 11 shows an example of a data table showing electronic apparatuses and their terminal information in the embodiment of the present invention;

FIG. 12 shows an example of a data table showing the set notification priority in the embodiment of the present invention; and

FIG. 13 shows a main part of a management server in the embodiment of the present invention.

### DETAILED DESCRIPTION OF THE INVENTION

### Overview of Communication System

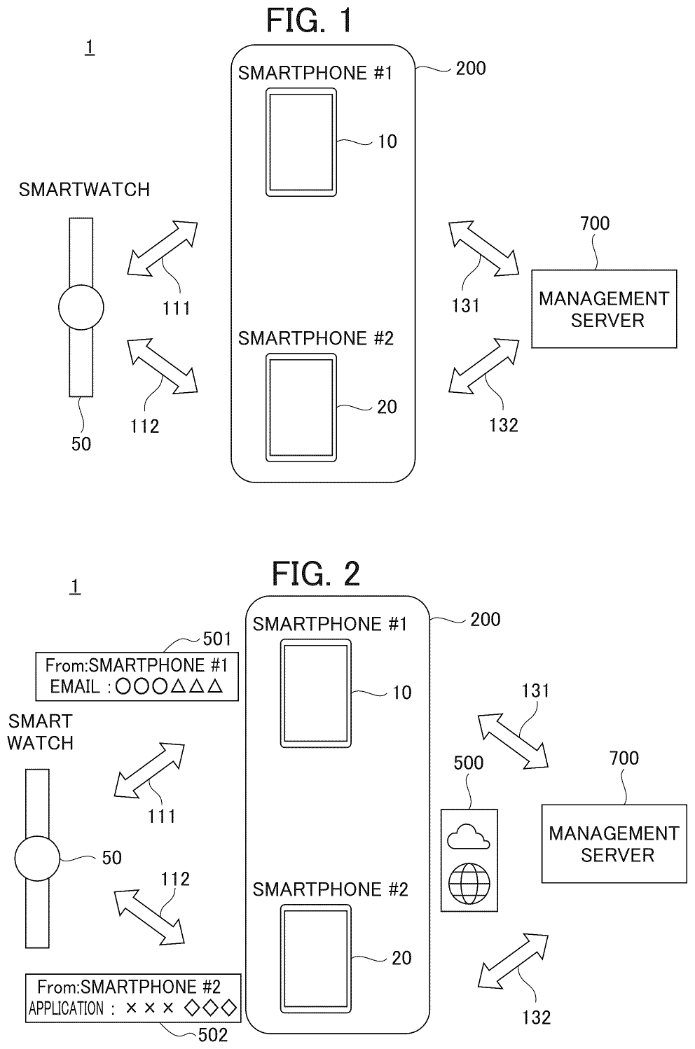

A communication system 1 and the like in an embodiment of the present invention is described with reference to the drawings. First, referring to FIG. 1, an overview of the communication system 1 is described. FIG. 1 shows the overview of the communication system in the embodiment of the present invention. As shown in FIG. 1, the communication system 1 includes a first electronic apparatus 10, a second electronic apparatus 20, a terminal apparatus 50, and a management server 700.

### Electronic Apparatus

The first electronic apparatus 10 and the second electronic apparatus 20 are communication-capable electronic terminals. The communication encompasses communication with another electronic apparatus, communication with the terminal apparatus 50, communication with a cloud server, and other various forms of communication. Examples of the first electronic apparatus 10 and the second electronic apparatus 20 include a smartphone, a tablet PC and the like. In the example shown in FIG. 1 and the like, the first electronic apparatus 10 is a smartphone #1. In the example shown in FIG. 1 and the like, the second electronic apparatus 20 is a smartphone #2. Note that the number of electronic apparatuses included in the communication system 1 may be three or more. In the following description, a third electronic apparatus is described as a third electronic apparatus 30.

### Terminal Apparatus

The terminal apparatus 50 is an apparatus that can be worn by a user, and displays a notification received by the electronic apparatus. Specifically, the terminal apparatus 50 is, for example, an apparatus that is worn by the user on a wrist or another body part and used, and is a communication-capable apparatus. However, the terminal apparatus 50 is not limited to an apparatus that is worn on the body part and used. Examples of the terminal apparatus 50 include a smartwatch and smart glasses. In the example shown in FIG. 1 and the like, the terminal apparatus 50 is a smartwatch.

### Management Server 700

A management server 700 is an information processing apparatus for realizing the communication system 1. The management server 700 is realized by, for example, a computer that has a server function. For example, the management server 700 executes various processes, transmits a processing result to the first electronic apparatus 10 and the second electronic apparatus 20, and causes the first electronic apparatus 10 and the second electronic apparatus 20 to execute operations according to the processing result, thereby realizing the communication system 1.

### Communication System

The communication system 1 is a system where the first electronic apparatus 10 and the second electronic apparatus 20, the terminal apparatus 50, and the management server 700 are connected to each other in a communication-capable manner. The communication system 1 includes a first communication, and a second communication.

### First Communication

The first communication is communication performed between the first electronic apparatus 10 and the second electronic apparatus 20, and the terminal apparatus 50. The first communication includes a first apparatus's first communication 111, and a second apparatus's first communication 112. The first apparatus's first communication 111 is communication performed between the first electronic apparatus 10 and the terminal apparatus 50. The second apparatus's first communication 112 is communication performed between the second electronic apparatus 20 and the terminal apparatus 50. Examples of the first communication include BLE (Bluetooth Low Energy), Bluetooth Classic (both are registered trademarks), etc.

### Second Communication

The second communication is communication performed between the first electronic apparatus 10 and the second electronic apparatus 20, and the management server 700, a cloud server, a website or the like. Examples of the second communication include network communication by a carrier line such as LTE (Long Term Evolution), mobile WiFi communication and the like. A processing result through execution by the management server 700 is transmitted to the first electronic apparatus 10 and the second electronic apparatus 20 via the second communication. The cloud server, the website or the like is called a cloud server or the like 500. The second communication includes the first apparatus's second communication 131, and the second apparatus's second communication 132. The first apparatus's second communication 131 is communication performed between the first electronic apparatus 10, and the management server 700 and the cloud server or the like 500. The second apparatus's second communication 132 is communication performed between the second electronic apparatus 20, and the management server 700 and the cloud server or the like 500.

### Functional Configuration

The functional configurations of the first electronic apparatus 10, the second electronic apparatus 20, and the terminal apparatus 50 are described. Note that in the following description, an overview of each component is described. The specific function of each component is described along with the description of a communication method according to the present embodiment. Note that not all the components described below are necessarily included, and unnecessary components are not required to be included. The first electronic apparatus 10, the second electronic apparatus 20, the terminal apparatus 50, and the information processing apparatus may include, besides components described below, for example, a portion that performs a computation process, a portion that stores information and the like as required.

### First Electronic Apparatus

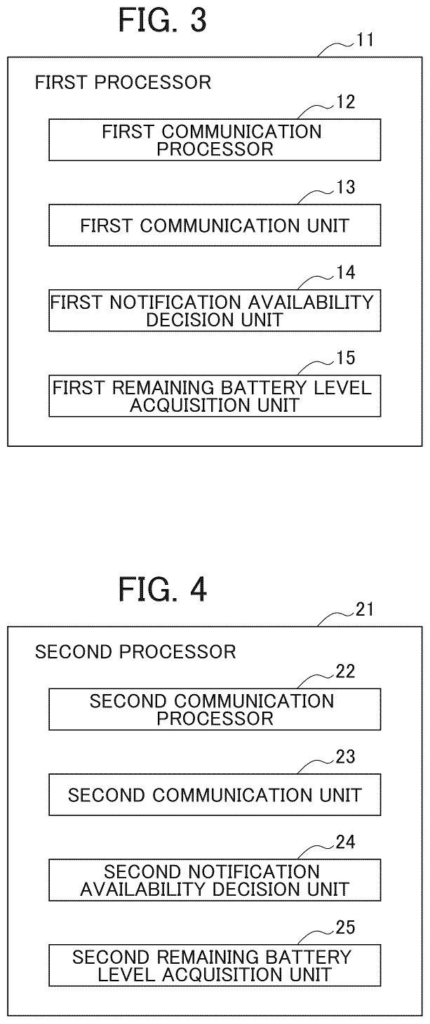

Referring to FIG. 3, the functional configuration of the first electronic apparatus 10 is described. FIG. 3 shows the functional configuration of the first electronic apparatus. The first electronic apparatus 10 includes a first processor 11. As shown in FIG. 3, the first processor 11 includes a first communication processor 12, a first communication unit 13, a first notification availability decision unit 14, and a first remaining battery level acquisition unit 15.

The first communication processor 12 is a portion that controls communication by the first communication unit 13. The first communication unit 13 performs a first communication with the terminal apparatus 50, a second communication with the management server 700, and the cloud server or the like 500, and the like. The first notification availability decision unit 14 is a portion that decides which electronic apparatus's notification item the terminal apparatus 50 issues, based on a set notification priority, when the terminal apparatus 50 wirelessly communicates with a plurality of electronic apparatuses. The first remaining battery level acquisition unit 15 is a portion that acquires the remaining battery level of the first electronic apparatus 10.

### Second Electronic Apparatus

Referring to FIG. 4, the functional configuration of the second electronic apparatus 20 is described. FIG. 4 shows the functional configuration of the second electronic apparatus. The second electronic apparatus 20 includes a processor similar to that of the first electronic apparatus 10. The second electronic apparatus 20 includes a second processor 21. As shown in FIG. 4, the second processor 21 includes a second communication processor 22, a second communication unit 23, a second notification availability decision unit 24, and a second remaining battery level acquisition unit 25. The function of each component is similar to the function of each corresponding component of the first electronic apparatus 10.

### Terminal Apparatus

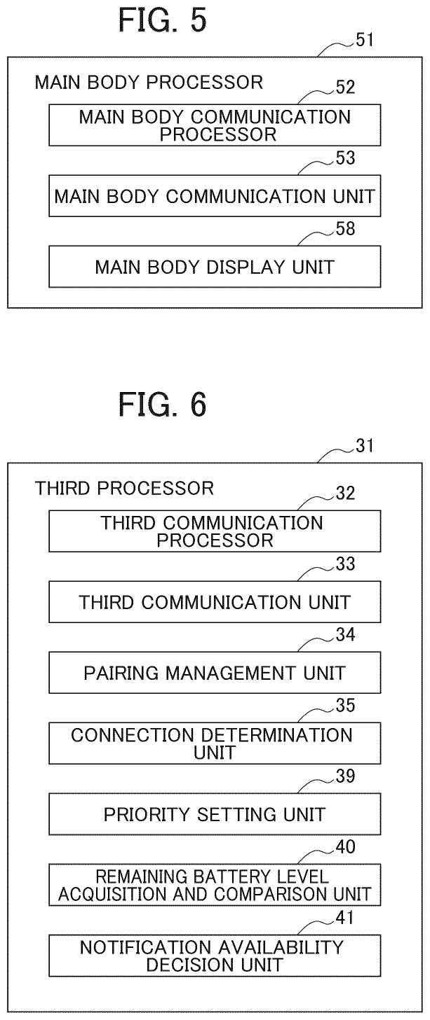

Referring to FIG. 5, the functional configuration of the terminal apparatus 50 is described. FIG. 5 shows the functional configuration of the terminal apparatus 50. The terminal apparatus 50 includes a main body processor 51. As shown in FIG. 5, the main body processor 51 includes a main body communication processor 52, a main body communication unit 53, and a main body display unit 58. The main body communication processor 52 is a portion that controls communication by the main body communication unit 53. The main body communication unit 53 is a portion that performs a second communication and the like with the electronic apparatus. The main body display unit 58 is a portion that displays notifications and the like received from the electronic apparatus.

### Management Server 700

Referring to FIG. 6, the functional configuration of the management server 700 is described. FIG. 6 shows the functional configuration of the management server 700. The management server 700 includes a third processor 31. As shown in FIG. 6, the management server 700 includes a third communication processor 32, a third communication unit 33, a pairing management unit 34, a connection determination unit 35, a priority setting unit 39, a remaining battery level acquisition and comparison unit 40, and a notification availability decision unit 41. The third communication processor 32 is a portion that controls communication by the third communication unit 33. The third communication unit 33 is a portion that performs a second communication and the like with another electronic apparatus. The pairing management unit 34 is a portion that manages pairing between electronic apparatuses belonging to the same pairing group 200. The connection determination unit 35 is a portion that determines whether all the electronic apparatuses belonging to the same pairing group 200 are connected to the terminal apparatus 50 or not. The priority setting unit 39 is a portion that sets the priority, based on setting information on the notification priority received from each electronic apparatus. The remaining battery level acquisition and comparison unit 40 is a portion that acquires the remaining battery level of the respective electronic apparatuses, and compares them. The notification availability decision unit 41 is a portion that determines whether the priority setting is “each electronic apparatus” or “variable depending on battery”.

### Pairing Group

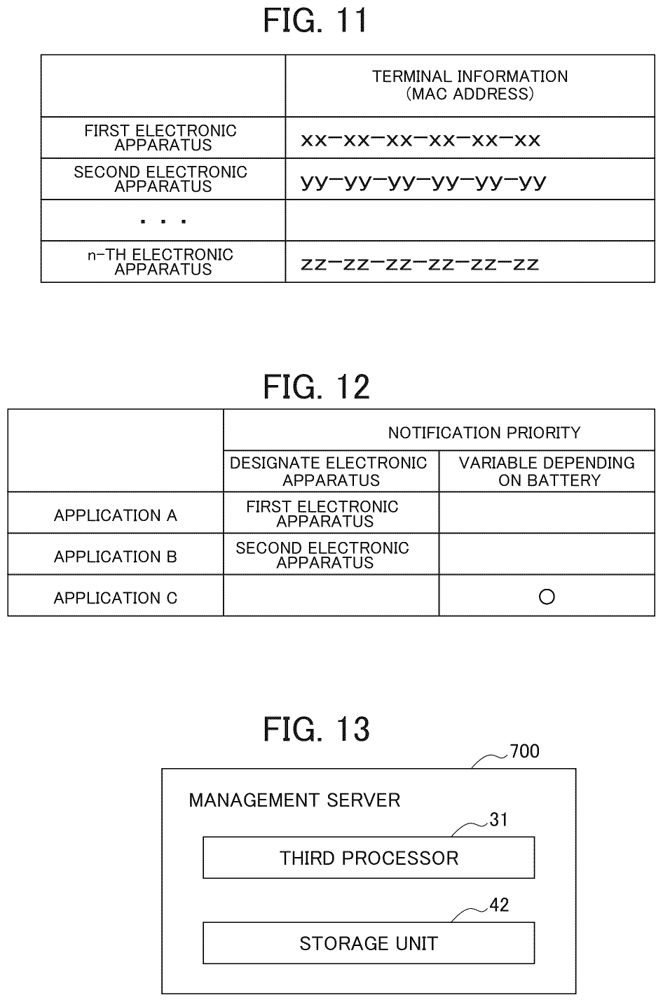

The first electronic apparatus 10 and the second electronic apparatus 20 are managed as electronic apparatuses belonging to the same pairing group 200. The pairing group 200 is a group based on which an application that groups the electronic apparatuses pairs the electronic apparatuses in a communication-capable manner and manages them. The application that groups the electronic apparatuses is called a pairing management application. The pairing management application is connected to the management server via the second communication, and can execute a process according to an operation input on the pairing management application, in the processor of the management server. The pairing management unit 34 of the management server manages, as the pairing group, terminal information on the electronic apparatuses included in the communication system 1. Here, the managing indicates, for example, grasping, storing and the like. For example, the pairing management unit 34 stores the terminal information in the storage unit 42, thus managing this information for the pairing group. Examples of the terminal information include a MAC address (Media Access Control address), a phone number, an ID set for the application or the like. In the example shown in FIG. 1 and the like, the pairing management unit 34 stores, in the storage unit 42, the terminal information on the first electronic apparatus 10 received from the first communication unit 13 of the first electronic apparatus 10, and manages this information for the pairing group 200. Likewise, the pairing management unit 34 stores, in the storage unit 42, the terminal information on the electronic apparatus 20 transmitted from the second communication unit 23 of the second electronic apparatus 20, and manages this information for the pairing group 200. This allows the first electronic apparatus 10 and the second electronic apparatus 20 to belong to the same pairing group 200. Note that a data table that indicates the electronic apparatuses and their terminal information may be created in the storage unit 42 of the management server, thus allowing the pairing group 200 to be managed. FIG. 11 shows an example of the data table that indicates the electronic apparatuses and their terminal information. FIG. 11 shows an example where the terminal information is MAC addresses. Note that n in FIG. 11 indicates the number of electronic apparatuses belonging to the same pairing group 200.

### Display Example on Terminal Apparatus

Referring to FIG. 2, a display example on the terminal apparatus 50 is described. FIG. 2 shows an example of notifications in the communication system in the embodiment of the present invention. As shown in FIG. 2, a notification received by the first electronic apparatus 10, and a notification received by the second electronic apparatus 20 are displayed on the terminal apparatus 50. The notification is, for example, a notification received by the application installed in the first electronic apparatus 10 from a network server or the like. A first displayed item 501 in FIG. 2 indicates an example of the notification received by the first electronic apparatus 10 and displayed on the terminal apparatus 50. A second displayed item 502 indicates an example of the notification received by the second electronic apparatus 20 and displayed on the terminal apparatus 50.

Description is made using the first electronic apparatus 10 as an example. The first electronic apparatus 10 receives a notification issued by an application installed in the first electronic apparatus 10. The notification is received via the second communication.

The notification is received via the second communication from the cloud server or the like 500 depending on the type of application. Examples of the notification include a notification about “mail is received” at the application pertaining to email, a notification about “weather information” at the application pertaining to weather, and a notification about “earthquake occurrence” at the application pertaining to an emergency notification. The first displayed item 501 indicates the notification about an email received by the first electronic apparatus 10. The first displayed item 501 includes a displayed item “FROM SMARTPHONE #1” indicating the electronic apparatus having received the notification, and a displayed item “EMAIL: ∘∘∘ΔΔΔ” about the notification item. This also applies to the second electronic apparatus 20 in a manner similar to that of the first electronic apparatus 10. The second electronic apparatus 20 receives the notification via the second apparatus's second communication 132. The second displayed item 502 indicates the notification about the application received by the second electronic apparatus 20. The second displayed item 502 includes a displayed item “FROM SMARTPHONE #2” indicating the electronic apparatus having received the notification, and a displayed item “application: xxx⋄⋄⋄” about the notification item.

As the overview of the communication system 1, an aspect is described above where the notification received by the first electronic apparatus 10 and the notification received by the second electronic apparatus 20 are transmitted to the terminal apparatus 50 at normal times and are displayed on the terminal apparatus 50. The normal times indicate, for example, a state where no electronic apparatus is disconnected from communication and is appropriately connected. Respective embodiments are sequentially described below.

### Embodiment

A communication system 1 and the like in an embodiment of the present invention is described with reference to the drawings. The communication system 1 in the present embodiment prevents the identical type of notifications from being redundantly displayed on the terminal apparatus 50.

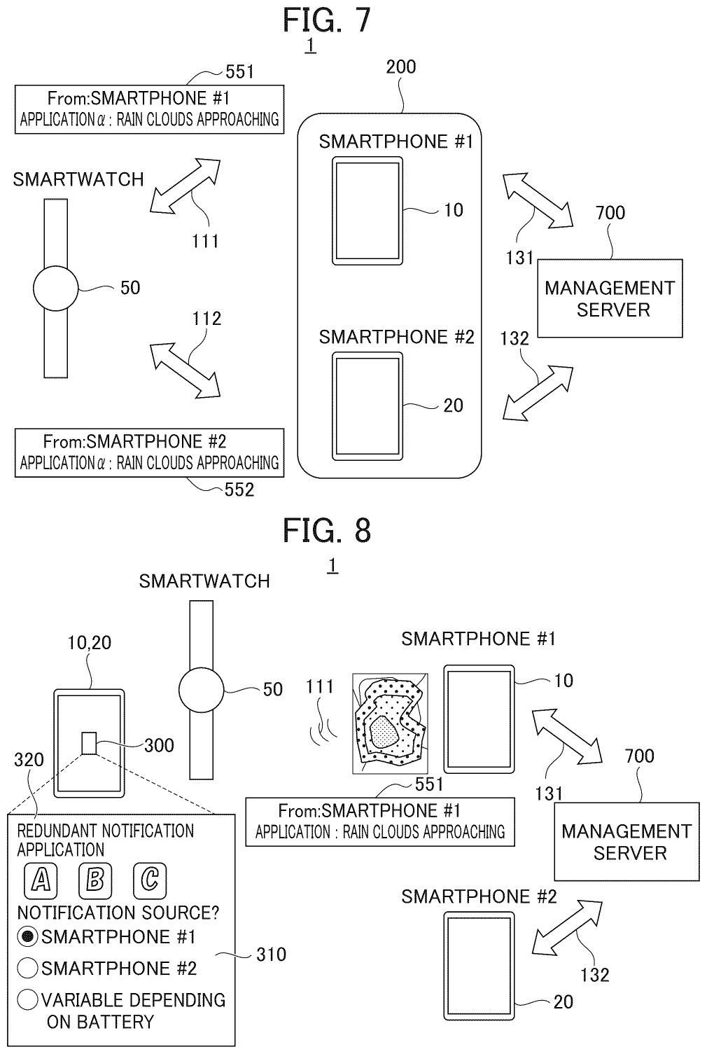

FIG. 7 shows a state where notifications of the identical type are redundantly displayed on the terminal apparatus 50. For example, in a case where the same application is installed in the first electronic apparatus 10 and the second electronic apparatus 20, notifications about the same item may be displayed on the terminal apparatus 50 with little time between them. This is because the first electronic apparatus 10 and the second electronic apparatus 20 sometimes receive notifications of the identical type from the cloud server or the like 500 at approximately the same time. The notification is transmitted from the first electronic apparatus 10 and the second electronic apparatus 20 to the terminal apparatus 50 via the first apparatus's first communication 111 or the second apparatus's first communication 112 respectively, and displayed on the terminal apparatus 50. FIG. 7 shows an example where a notification “rain clouds approaching” from the application pertaining to weather is redundantly displayed on the terminal apparatus 50.

In the communication system 1 in the present embodiment, the first electronic apparatus 10 and the second electronic apparatus 20 belong to the same pairing group 200. In the pairing group 200, the electronic apparatuses are assigned the priority orders. Specifically, the electronic apparatus from which the received notification is to be transmitted to the terminal apparatus 50 is predefined. This can prevent a redundant notification from being displayed on the terminal apparatus 50.

FIG. 8 shows an example of setting the notification priority in the communication system 1 in the present embodiment. The notification priority (transmission priority) is the priority order indicating the electronic apparatus from which the redundant notification is to be transmitted to the terminal apparatus 50. That is, the notification priority means the priority order, about the redundant notification, indicating which electronic apparatus's received notification is to be transmitted to the terminal apparatus 50.

In the communication system 1 in the present embodiment, the application that manages the pairing group 200 includes the application that sets the notification priority. The application that sets the notification priority is called a priority order adoption notification application 300. The priority order adoption notification application 300 is connected to the management server 700 via the second communication, and can cause the processor 31 of the management server 700 to execute a process according to an operation input through the priority order adoption notification application 300. The priority order adoption notification application 300 may be configured as part of the pairing management application. The priority order adoption notification application 300 may be operated through any electronic apparatus belonging to the same pairing group 200. That is, the user can set the notification priority via any electronic apparatus belonging to the same pairing group 200. In the example shown in FIG. 8, the user can activate the priority order adoption notification application 300 and set the notification priority, at any electronic apparatus freely selected from the first electronic apparatus 10 and the second electronic apparatus 20.

A displayed item 310 in FIG. 8 shows an example of a setting screen of the priority order adoption notification application 300. On the setting screen of the priority order adoption notification application 300 there is displayed an application that is redundantly installed in the first electronic apparatus 10 and the second electronic apparatus 20 and accompanied by a notification. The application redundantly installed and accompanied by a notification is called a redundant notification application 320. In the diagram shown in FIG. 8, an application A, an application B, and an application C are illustrated as examples of the redundant notification application 320.

The notification priority may be preset with respect to each of the redundant notification applications 320 on the setting screen of the priority order adoption notification application 300. In the example shown in FIG. 8, the notification priority can be set by selecting from among the priority assigned to the smartphone #1, the priority assigned to the smartphone #2, and variable depending on the battery. Note that these alternatives are only examples. Other alternatives include, for example, the size of the electronic apparatus, the weight of the electronic apparatus, the use frequency of the electronic apparatus, and other various alternatives.

“Variable depending on the battery” indicates, for example, transmission of a notification from the electronic apparatus having higher remaining battery level to the terminal apparatus 50, with the priority being assigned to what has higher remaining battery level.

The management server 700 can detect the remaining battery level of every electronic apparatus by acquiring the remaining battery level from every electronic apparatus belonging to the same pairing group 200 using the second communication. It is decided from which electronic apparatus the notification is to be transmitted to the terminal apparatus 50, based on this detection result. The remaining battery level changes anytime depending on the mode of use of the electronic apparatus and the manner of charging. At a point in time when the redundant notification application 320 receives the notification from the cloud server or the like 500, the management server 700 acquires the remaining battery level from every electronic apparatus belonging to the same pairing group 200. Accordingly, an appropriate electronic apparatus can be selected depending on the actual situation of the remaining battery level. In the example shown in FIG. 8, as indicated in the displayed item 310, “SMARTPHONE #1” is selected as what has a high notification priority.

Accordingly, when the first electronic apparatus 10 and the second electronic apparatus 20 receive redundant notifications, only the first electronic apparatus 10 transmits the notification to the terminal apparatus 50. As a result, only the notification from the first electronic apparatus 10 is displayed on the terminal apparatus 50. A displayed item 551 in FIG. 8 indicates the notification from the first electronic apparatus 10. Accordingly, the redundant notification displayed on the terminal apparatus 50 as shown in FIG. 7 can be eliminated.

Note that in setting of the notification priority for the priority order adoption notification application 300 and the like, the user may register the redundant notification application 320. Alternatively, the priority order adoption notification application 300 and the like may automatically acquire the redundant notification application 320 from each electronic apparatus and the like and set it. This case does not require any operation by the user. In setting of the notification priority, a data table that indicates the set item may be created in the storage unit 42 of the management server 700. FIG. 12 shows an example of the data table that indicates the set notification priority. In the example shown in FIG. 12, for the application A, the first electronic apparatus is given priority. For the application B, the second electronic apparatus is given priority. For the application C, the priority is set to be variable depending on the battery.

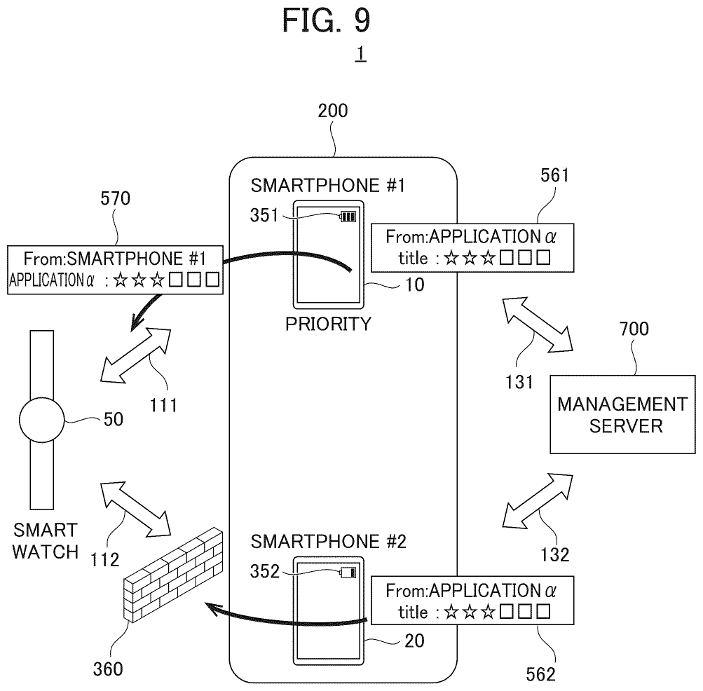

Referring to FIG. 9, another example of the communication system 1 in the embodiment is described. FIG. 9 shows the other example of the communication system 1 in the embodiment. In the example shown in FIG. 8, “SMARTPHONE #1” is selected as what is assigned the notification priority. In contrast, the example shown in FIG. 9 shows a case where “variable depending on battery” is selected as the notification priority.

In the case where “variable depending on battery” is selected as the notification priority, when the electronic apparatus receives a notification, the remaining battery level is compared among the electronic apparatuses belonging to the same pairing group 200. In the example shown in FIG. 9, when the first electronic apparatus 10 receives a notification 561 and the second electronic apparatus 20 receives a notification 562, the first electronic apparatus 10 and the second electronic apparatus 20 transmit their remaining battery level to the management server 700, and the management server 700 compares the electronic apparatuses' remaining battery level. Note that the notification 561 and the notification 562 are notifications of the identical type. The remaining battery level 351 of the first electronic apparatus 10 is higher than the remaining battery level 352 of the second electronic apparatus 20. The first electronic apparatus 10 has priority over the second electronic apparatus 20. As a result, the transmission of the notification to the terminal apparatus 50 is performed from the first electronic apparatus 10. The transmission of the notification from the second electronic apparatus 20 to the terminal apparatus 50 is blocked as indicated by a wall 360, for example. Specifically, the wall 360 is a function of deciding the notification availability, based on the notification priority set in the management server 700. The redundant notification can be filtered by the wall 360, and be delivered to the terminal apparatus 50. Note that the function of the wall 360 may be provided in the terminal apparatus 50 as described later. On the terminal apparatus 50, the notification 561 transmitted from the first electronic apparatus 10 is displayed as a displayed item 570.

### Communication Method

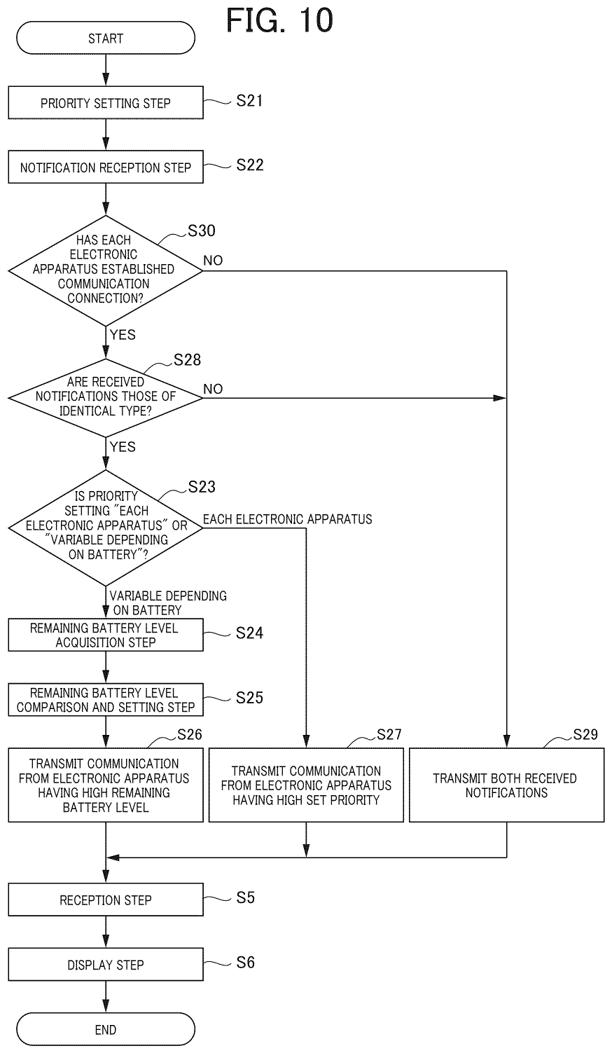

Referring to FIG. 10, a communication method according to the present embodiment is described. FIG. 10 is a flowchart showing the processing procedures of the communication method according to the present embodiment.

### S21

S21 indicates a priority setting step. The priority setting step sets the notification priorities among the electronic apparatuses belonging to the same pairing group. In setting of the notification priority, for example, when the user performs an input operation for the notification priority through the priority order adoption notification application 300 installed in the first electronic apparatus 10 and the second electronic apparatus 20, the setting information on the notification priority is transmitted to the management server 700 according to the operation. The priority setting unit 39 of the management server 700 sets the priority, based on the received setting information on the notification priority. For example, in the priority setting step, the data table indicating the correspondence relationship between the electronic apparatus and the notification priority in the storage unit 42 is created, thereby allowing the notification priority to be set.

### S22

S22 indicates a notification reception step. In the notification reception step, the management server 700 receives information on the notification received by each electronic apparatus from the cloud server or the like 500. In an example shown in FIG. 8 and the like, upon receipt of a notification (first information) from the cloud server or the like 500, the first electronic apparatus 10 transmits information on the notification to the management server 700. Likewise, upon receipt of a notification (second information) from the cloud server or the like 500, the second electronic apparatus 20 transmits information on the notification to the management server 700. Reception of the information on the notification is performed by the first communication unit 13 and the second communication unit 23.

### S30

S30 indicates a connection determination step. In the connection determination step, the connection determination unit 35 determines whether each electronic apparatus having received the notification from the cloud server or the like 500 is connected to the terminal apparatus 50 or not. For example, each electronic apparatus transmits, to the management server 700, the notification received from the cloud server 500, and transmits, to the management server 700, information on the situation of connection to the terminal apparatus 50. The management server 700 determines whether the electronic apparatus is connected to the terminal apparatus 50 or not based on the received information on the situation of connection. If the information on the connection situation received by the management server 700 from each electronic apparatus is information indicating that the connection to the terminal apparatus 50 is established, the connection determination unit 35 determines that each electronic apparatus has established communication connection. If the determination in S30 is “YES”, the step proceeds to S28. If the determination in S30 is “NO”, the step proceeds to S29. Note that each electronic apparatus may transmit the information on the situation of connection, to the management server 700, at timing of establishing communication connection to or disconnecting from the terminal apparatus 50. In this case, the management server 700 creates, in the storage unit 42, a data table indicating the connection situation at the timing of receiving the information on the connection situation, thereby enabling the connection situation between each electronic apparatus and the terminal apparatus 50 to be managed.

### S28

S28 indicates a notification type identicalness determination step. The notification type identicalness determination step is a step of determining whether the notification received by each electronic apparatus is the identical type of notification or not based on the information on the notification received by the management server 700 from the corresponding electronic apparatus. The information on the notification is, for example, the notification reception timing, email address and other pieces of notification transmission source information, the application having transmitted the notification, the items of the notification, etc. If the determination in S28 is “YES”, the step proceeds to S23. If the determination in S28 is “NO”, the step proceeds to S29. In the example shown in FIG. 8 and the like, upon receipt of a notification from the first electronic apparatus 10 and the second electronic apparatus 20, the processor 31 of the management server 700 determines whether the received notification is the notification of the identical type or not, and if it is the identical type of notification, the processing proceeds to S23. For example, the processor 31 of the management server 700 determines that the notification is of the identical type, based on the information on the notification received from each electronic apparatus, if the time difference between the time of receiving the notification by the first electronic apparatus 10 and the time of receiving the notification by the second electronic apparatus 20 is in a predetermined range, and the timing of receiving the notification by each electronic apparatus is substantially identical. Alternatively, if the notification received by the first electronic apparatus and the notification received by the second electronic apparatus 20 are notifications from the redundant notification application 320, the notifications may be determined to be of the identical type. Note that if the timing of receiving the notification by each electronic apparatus is different, even when the notification is from the redundant notification application 320, it may be determined not to be of the identical type. The case where the timing of receiving the notification by each electronic apparatus is different is a case where the time difference between the time of receiving the notification by the first electronic apparatus 10 and the time of receiving the notification by the second electronic apparatus 20 is outside the predetermined range. Furthermore, if the transmission source of the notification received by the first electronic apparatus 10 and the transmission source of the notification received by the second electronic apparatus 20 are the same, the notifications may be determined to be of the identical type. Alternatively, if the notification item of the notification received by the first electronic apparatus 10 and the notification item of the notification received by the second electronic apparatus 20 are the same, the notifications may be determined to be of the identical type.

S23 to S25 are part of steps of a notification availability decision step. The notification availability decision step is a step of deciding whether the terminal apparatus 50 issues a notification about the notification item from each electronic apparatus or not based on the set notification priority. The following is a sequential description.

### S23

S23 indicates a step of determining whether the priority setting is “each electronic apparatus” or “variable depending on battery”. This determination is performed by the notification availability decision unit 41. In this determination, the notification availability decision unit 41 can refer to information on the aforementioned data table that indicates the item set about the notification priority and is in the storage unit 42. If the determination in S23 indicates that the priority setting is “each electronic apparatus”, the step proceeds to S27. If the determination in S23 indicates that the priority setting is “variable depending on battery”, the step proceeds to S24.

### S27

S27 indicates a step of transmitting communication from the electronic apparatus having high priority setting, to the terminal apparatus 50. In the example shown in FIG. 8 and the like, the third communication unit 33 transmits information for causing the first electronic apparatus 10 with the set high notification priority to issue the notification, based on the set notification priority. When the first electronic apparatus 10 receives information for causing it to issue the notification, the first communication unit 13 of the first electronic apparatus 10 transmits the notification to the terminal apparatus 50. After S27, the step proceeds to S5.

### S24

S24 indicates a step of acquiring the remaining battery level of each of the electronic apparatuses belonging to the same pairing group. The acquisition of the remaining battery level is performed by the remaining battery level acquisition and comparison unit 40 of the management server 700. The remaining battery level acquisition and comparison unit 40 acquires the remaining battery level by receiving the remaining battery level acquired by the remaining battery level acquisition unit of each electronic apparatus. In an example shown in FIG. 9 and the like, the remaining battery level acquisition and comparison unit 40 uses the second communication to receive the remaining battery level acquired by each of a first remaining battery level acquisition unit 19 and a second remaining battery level acquisition unit 29, thus acquiring the remaining battery level of the first electronic apparatus 10 and the remaining battery level of the second electronic apparatus 20.

### S25

S25 indicates a step of comparing the remaining battery level of each of the electronic apparatuses belonging to the same pairing group, and setting the priority, based on the comparison result. In S25, the remaining battery level of each electronic apparatus acquired in S24 is compared. The comparison of the remaining battery level is performed by the remaining battery level acquisition and comparison unit 40 of the management server 700. In the example shown in FIG. 9 and the like, the remaining battery level acquisition and comparison unit 40 compares the acquired remaining battery level of the first electronic apparatus 10 and the acquired remaining battery level of the second electronic apparatus 20 with each other. The priority setting unit 39 sets the priority, based on the comparison result of the remaining battery level. In the example shown in FIG. 9 and the like, the priority setting unit 39 sets such that the first electronic apparatus 10 with higher remaining battery level has a higher notification priority than the second electronic apparatus 20 based on the comparison result of the remaining battery level.

### S26

S26 indicates a step of transmitting communication from the electronic apparatus with higher remaining battery level to the terminal apparatus 50. Based on the notification priority set in S25, the third communication unit 33 of the management server 700 transmits information for causing the first electronic apparatus 10 with a set high notification priority to issue a notification. When the first electronic apparatus 10 receives information for causing it to issue the notification, the first communication unit 13 of the first electronic apparatus 10 transmits the notification to the terminal apparatus 50. After S26, the step proceeds to S5. Note that the management server 700 may transmit information for causing the electronic apparatus with the set high notification priority to issue a notification, and may transmit information for preventing the electronic apparatus with the set low notification priority from issuing a notification. In this case, the electronic apparatus having received the information for preventing issuance of the notification may set a wall against the terminal apparatus 50.

### S29

S29 indicates a step of transmitting all the notifications received by the electronic apparatuses to the terminal apparatus 50. In this case, the management server 700 transmits information for issuing a notification, to the first electronic apparatus 10 and the second electronic apparatus 20. When the first electronic apparatus 10 and the second electronic apparatus 20 receive the information for issuing a notification, the first communication unit 13 of the first electronic apparatus 10 and the second communication unit 23 of the second electronic apparatus 20 transmit the notification to the terminal apparatus 50. After S29, the step proceeds to S5.

### S5

S5 indicates a reception step. In the reception step, the terminal apparatus 50 receives the notification transmitted from the electronic apparatus. The transmission of the notification to the terminal apparatus 50 is performed using the first communication. In the example shown in FIG. 2 and the like, the terminal apparatus 50 receives the notification from the first electronic apparatus 10 using the first apparatus's first communication 111. Specifically, the first communication unit 13 transmits the notification, and the main body communication unit 53 receives the notification.

### S6

S6 indicates a display step. In the display step, the terminal apparatus 50 displays the received notification. The notification is displayed on the main body display unit 58. In S6, the flow is finished.

### Hardware Configuration Example

Each hardware configuration included in the communication system 1 in each embodiment of the present embodiment is described. Each processor and the like included in the communication system 1 can be configured by a processor that performs processes for various types of computation, control and the like required to operate the communication system. The processor is, for example, a CPU (Central Processing Unit), an MPU (Micro Processing Unit), an SoC (System on a Chip), a DSP (Digital Signal Processor), a GPU (Graphics Processing Unit), an ASIC (Application Specific Integrated Circuit), a PLD (Programmable Logic Device), an FPGA (Field-Programmable Gate Array) or the like, or a combination of them. The processor may be a combination of such a processor, a hardware accelerator and the like.

As shown in FIG. 13, the management server 700 included in the communication system 1 of each embodiment in the present invention includes the storage unit 42 in addition to the third processor 31. The storage unit 42 has a role as what is called a secondary storage device (auxiliary storage device), and is a readable and writable nonvolatile flash memory, hard disk drive or the like, for example. The storage unit 42 stores programs that the processor executes, and various data items. For example, the storage unit 42 stores a data table that indicates the electronic apparatuses and their terminal information, a data table that indicates the set notification priorities and the like.

The present embodiment also encompasses the function of each function unit of the processor and the like included in the communication system, and programs for causing the processor to execute the communication method.

The series of processes described above may be executed by hardware, or executed by software. In other words, each functional configuration described above is only an example, and is not specifically limited. That is, it is sufficient that a function of executing the aforementioned series of processes as a whole is provided for the communication system 1 or the like. It is not specifically limited which functional block is used to realize the function, to the example described above. One functional block may be made up of a single piece of hardware, a single piece of software, or a combination of them. The functional configuration in the present embodiment is realized by the processor that executes the computation process. Processors that can be used for the present embodiment include what is made up of a single device among various processing devices, such as a single processor, a multiprocessor, and a multi-core processor, and a combination of any of the various types of processing devices, and any of processing circuits, such as an ASIC (Application Specific Integrated Circuit) and an FPGA (Field-Programmable Gate Array).

Note that in the present specification, steps that are executed by each unit included in the communication system 1 and are accompanied by data processing include not only processes performed according to the order in time series, but also processes that are executed in parallel or individually even if they are not necessarily processed in time series.

Some embodiments in the present invention have been described above. However, these embodiments are only examples, and do not limit the technical scope of the present invention.

The present invention can be implemented as other various embodiments. The configurations of the embodiment and modified examples can be combined. Furthermore, in a scope without departing from the gist of the present invention, omission, replacement, and other changes may be applied. These embodiments and their modifications are encompassed in the claims and gist of the invention described in the present specification and the like, and are encompassed in the invention described in the claims and their equivalent range.

For example, as for the display of the redundant notification on the terminal apparatus 50, the configuration example where the electronic apparatus does not transmit the redundant notification to the terminal apparatus 50 has been described. As to the redundant display, it can be adjusted such that the terminal apparatus 50 does not display the redundant item to be displayed. For example, the terminal apparatus 50 receives all the notifications received by the individual electronic apparatuses. Among the redundant notifications, only one notification may be displayed. The main body processor 51 can decide which notification the terminal apparatus 50 displays. This is the example where the function of the wall 360 pertaining to the notification availability decision described above is provided for the terminal apparatus 50.

That is, in the present disclosure, the decision of whether the terminal apparatus 50 issues a notification from the first electronic apparatus 10 and the second electronic apparatus 20 based on the set notification priority when the terminal apparatus 50 wirelessly communicates with the first electronic apparatus 10 and the second electronic apparatus 20 may be performed by the electronic apparatus or the terminal apparatus 50. For example, the decision of whether to issue the notification item or not and switching between them can be performed depending on whether to transmit the notification or not in the case of decision by the electronic apparatus, and depending on whether to display the notification or not in the case of decision by the terminal apparatus 50.

The communication system and the communication method according to the present disclosure may be described as follows. In a case where a plurality of smartphones are paired with, and transmit and receive a notification to and from one smartwatch, through a BLE connection, and where applications installed in the smartphones are redundant, notifications having the same item sometimes redundantly reach the smartwatch. The present disclosure relates to an application that can manage a plurality of smartphones paired with one smartwatch. For example, by assigning priority orders to the respective smartphones, redundant notifications are filtered and the filtered notification is delivered to the smartwatch. This can prevent the notification from being redundantly delivered, and provide a comfortable use environment.

Conventionally, the case where a terminal apparatus has established a communication connection to a plurality of mobile terminals as in Patent Literature 1, Japanese Unexamined Patent Application, Publication No. 2021-136457, has a problem that redundant notifications are transmitted from the mobile terminals to the terminal apparatus and displayed. The present invention has an object to provide an information processing apparatus, a communication system, a communication method, and a program that can prevent redundant notifications from being displayed on the terminal apparatus. According to the present embodiment described above, the management server 700 includes the third processor 31 that: sets a notification priority of each of the first electronic apparatus 10 capable of establishing a connection for communication with the terminal apparatus 50, and the second electronic apparatus 20 capable of establishing a connection for communication with the terminal apparatus 50; in a case of acquiring information indicating that the terminal apparatus 50 has established connections for communication with the first electronic apparatus 10 and the second electronic apparatus 20 and receiving first information received by the first electronic apparatus 10 and second information received by the second electronic apparatus 20, determines whether the first information and the second information are of an identical type or not; and in a case of determining that the first information and the second information are of the identical type, decides which of the first information and the second information is to be transmitted to the terminal apparatus 50, based on the notification priority having been set. This can prevent redundant notifications from being displayed on the terminal apparatus 50.

The third processor 31 decides to issue, to the terminal apparatus 50, a notification received by whichever of the first electronic apparatus 10 and the second electronic apparatus 20 that has a higher set notification priority. This enables the notification from the electronic apparatus having the higher set notification priority to be received.

The third processor 31 can set the notification priority, depending on the remaining battery level of the first electronic apparatus 10 and the remaining battery level of the second electronic apparatus 20. This allows the terminal apparatus 50 to display a required notification without further reducing the remaining battery level of the electronic apparatus having low remaining battery level, for example.

In a case where the first information and the second information are received at substantially identical timing, the third processor 31 may determine that the first information and the second information are of the identical type. According to such a configuration, the redundant notifications can be prevented from being displayed on the terminal apparatus 50 since the notifications having been received at the identical timing are highly possibly notifications of the identical type.

The third processor 31 may store applications redundantly installed in the first electronic apparatus 10 and the second electronic apparatus 20 as a redundant notification application 320 in the storage unit 42, and determine that the first information and the second information are of the identical type in a case where the first information and the second information have been transmitted from the redundant notification application 320. According to such a configuration, notifications of the identical type can be more securely prevented from being displayed on the terminal apparatus 50.

In a case where the first information and the second information have been transmitted at different timings from the redundant notification application 320, the third processor 31 can determine that the first information and the second information are not of the identical type. This can reduce cases where necessary items to be displayed are not displayed in an erroneous manner. Even in a case where notifications are from the same application, there is a possibility that if the timing is different, the items of the notifications are different from each other. For example, in a case where electronic apparatuses log in the same application with different IDs, and the like, notifications having different items may sometimes be issued from the same application at different timings.

The third processor 31 may acquire information on transmission sources of the first information and the second information, and determine that the first information and the second information are of the identical type in a case where the transmission sources are identical. According to such a configuration, notifications of the identical type can be more securely prevented from being displayed on the terminal apparatus 50.

The third processor 31 may acquire notification items of the first information and the second information, and determine that the first information and the second information are of the identical type in a case where the notification items are of an identical type. For example, different applications are installed in the first electronic apparatus 10 and the second electronic apparatus 20. However, even if notifications having the similar items, such as weather information, are issued from the different applications, the notifications having the redundant items can be prevented from being displayed on the terminal apparatus 50.

The present embodiment described above includes the communication system 1 that includes the management server 700, the terminal apparatus 50, the first electronic apparatus 10, and the second electronic apparatus 20, the communication method executed in the communication system 1, and a program causing a computer to execute the communication method. These can prevent redundant notifications from being displayed on the terminal apparatus 50.

What is claimed is:

1. An information processing apparatus, comprising a processor that:
sets a transmission priority of each of a first electronic apparatus capable of establishing a connection for communication with a terminal apparatus, and a second electronic apparatus capable of establishing a connection for communication with the terminal apparatus;
in a case of acquiring information indicating that the terminal apparatus has established connections for communication with the first electronic apparatus and the second electronic apparatus and receiving first information received by the first electronic apparatus and second information received by the second electronic apparatus, determines whether the first information and the second information are of an identical type or not; and
in a case of determining that the first information and the second information are of the identical type, decides which of the first information and the second information is to be transmitted to the terminal apparatus, based on the transmission priority having been set.

2. The information processing apparatus according to claim 1, wherein
the processor decides to transmit, to the terminal apparatus, information received by whichever of the first electronic apparatus and the second electronic apparatus that has transmission priority set higher.

3. The information processing apparatus according to claim 1, wherein
in a case of receiving the first information and the second information, the processor acquires a remaining battery level of the first electronic apparatus and a remaining battery level of the second electronic apparatus, and the processor sets the transmission priority in accordance with the remaining battery level of the first electronic apparatus and the remaining battery level of the second electronic apparatus.

4. The information processing apparatus according to claim 1, wherein
in a case of receiving the first information and the second information at substantially identical timing, the processor determines that the first information and the second information are of the identical type.

5. The information processing apparatus according to claim 1, wherein the processor:
causes a storage unit to store therein an application redundantly installed in the first electronic apparatus and the second electronic apparatus, as a redundant application; and
determines that the first information and the second information are of the identical type if the first information and the second information have been transmitted from the redundant application.

6. The information processing apparatus according to claim 5, wherein
even in a case where the first information and the second information have been transmitted from the redundant application, if the first information and the second information have been received at different timings, the processor determines that the first information and the second information are not of the identical type.

7. The information processing apparatus according to claim 1, wherein
the processor acquires information on transmission sources of the first information and the second information, and determines that the first information and the second information are of the identical type if the transmission sources are identical.

8. The information processing apparatus according to claim 1, wherein
the processor acquires notification items of the first information and the second information, and determines that the first information and the second information are of the identical type if the notification items are of an identical type.

9. A communication method for use in a notification system including an information processing apparatus, a terminal apparatus, a first electronic apparatus, and a second electronic apparatus, the communication method comprising:
setting a transmission priority of each of the first electronic apparatus capable of establishing a connection for communication with the terminal apparatus, and the second electronic apparatus capable of establishing a connection for communication with the terminal apparatus;
in a case of acquiring information indicating that the terminal apparatus has established connections for communication with the first electronic apparatus and the second electronic apparatus and receiving first information received by the first electronic apparatus and second information received by the second electronic apparatus, determining whether the first information and the second information are of an identical type or not; and
in a case of determining that the first information and the second information are of the identical type, deciding which of the first information and the second information is to be transmitted to the terminal apparatus, based on the transmission priority having been set.

10. A program that causes a computer to function as a processor that:
sets a transmission priority of each of a first electronic apparatus capable of establishing a connection for communication with a terminal apparatus, and a second electronic apparatus capable of establishing a connection for communication with the terminal apparatus;
in a case of acquiring information indicating that the terminal apparatus has established connections for communication with the first electronic apparatus and the second electronic apparatus and receiving first information received by the first electronic apparatus and second information received by the second electronic apparatus, determines whether the first information and the second information are of an identical type or not; and
in a case of determining that the first information and the second information are of the identical type, decides which of the first information and the second information is to be transmitted to the terminal apparatus, based on the transmission priority having been set.

11. The program according to claim 10, wherein
the processor decides to transmit, to the terminal apparatus, the information that is received by whichever of the first electronic apparatus and the second electronic apparatus that has transmission priority set higher.

12. The program according to claim 10, wherein
in a case of receiving the first information and the second information, the processor acquires a remaining battery level of the first electronic apparatus and a remaining battery level of the second electronic apparatus, and the processor sets the transmission priority in accordance with the remaining battery level of the first electronic apparatus and the remaining battery level of the second electronic apparatus.

13. The program according to claim 10, wherein
in a case of receiving the first information and the second information at substantially identical timing, the processor determines that the first information and the second information are of the identical type.
